(19) United States
(12) Patent Application Publication
(10) Pub. No.: US 2007/0026918 A1
(43) Pub. Date: Feb. 1, 2007

(54) Upgradeable pinball machine

(75) Inventor: Lyman F. Sheats JR., Hoffman Estates, IL (US)

Correspondence Address: GREENBERG TRAURIG, LLP, 77 WEST WACKER DRIVE, SUITE 2500, CHICAGO, IL, 60601-1732, US

(73) Assignee: Stern Pinball, Inc., Melrose Park, IL (US)

(21) Appl. No.: 11/495,193

(22) Filed: Jul. 28, 2006

Related U.S. Application Data
(60) Provisional application No. 60/704,382, filed on Aug. 1, 2005.

(51) Int. Cl. A63F 13/00

(52) U.S. Cl. 463/3

(57) ABSTRACT

A method for updating the programming of a pinball machine, including, but not limited to, game programming, game sounds, and/or game images using a USB (universal serial bus) memory drive, e.g., a USB memory stick or USB memory key, as the mechanism to transport the programming to the pinball machine.

### BACKGROUND

In the art, systems for retrofitting a pinball machine are known. For example, U.S. Pat. Nos. 6,155,565 and 6,199,861 illustrate and describe methods for retrofitting a pinball machine and, more particularly, the programming associated with the electronics that are used to control the operation of the pinball machine. In one described embodiment, the programming is updated by inserting a flash memory card into an ISA slot of a motherboard. In another described embodiment, a technician tasked with the retrofitting process uses a portable computer which contains within its memory the replacement information whereupon the computer is connected to an associated port within the electronics via a signal-carrying cable for downloading the replacement information for the new game. In yet another described embodiment, the electronics may include a simple memory disc drive (e.g., a floppy disc) which receives a disc with the new, replacement information. Thus, the electronics would then transfer the replacement information from the disc into the memory of the electronics or the system could operate simply by relying on pulling the information from the disc during normal pinball operation (in other words, the technician simply replaces the first game disc with a second game disc). In a still further described embodiment, the technician replaces the memory chips of the system with new memory chips supplied with a conversion kit. To accomplish this, the PCI bus card assembly is described as being removed from the controller box, the daughter card is disengaged from the PCI bus card assembly, and the memory chips are removed from the daughter card whereupon the new memory chips supplied with the conversion kit are then installed into the daughter card, the daughter card is reengaged to the PCI bus card assembly, and the PCI bus card assembly is placed back into the controller box.

While these methods for retrofitting a pinball machine generally work for their intended purpose, what is needed is an improved method for updating programming associated with a pinball machine, in particular, one which allows for the convenient transportation of the programming as well as one which allows for the programming to be installed quickly and easily.

### SUMMARY

In accordance with these and other needs, the following describes a system and method for updating the programming of a pinball machine, including, but not limited to, game programming, game sounds, and/or game images, using a USB (universal serial bus) memory drive, e.g., a USB memory stick or USB memory key, as the mechanism to transport the programming to the pinball machine.

A better understanding of the objects, advantages, features, properties and relationships of the system and method will be obtained from the following detailed description and accompanying drawings which set forth illustrative embodiments which are indicative of the various ways in which the principles of the invention may be employed.

### BRIEF DESCRIPTION OF THE DRAWINGS

For a better understanding of the system and method for updating a pinball machine described hereinafter, reference may be had to the following drawings in which:

FIG. 1 is an isometric view of an exemplary pinball machine; and

FIG. 2 is a block diagram of exemplary pinball machine electronic components.

### DETAILED DESCRIPTION

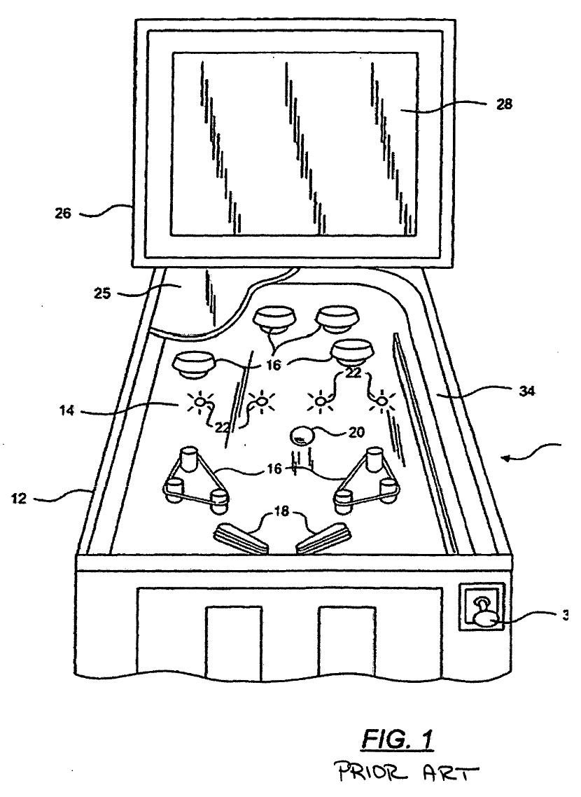

With reference to the FIG. 1, reproduced from EP Patent Application 0 992 264, an exemplary pinball machine 10 is generally described. More particularly, as set forth in EP Patent Application 0 992 264, the pinball machine 10 includes a cabinet 12 which houses various apparatus for defining pinball play. Generally speaking, the pinball machine 10 includes an inclined playfield 14 that supports a number of playfield accessories or devices 16. A pair of flippers 18 is usually provided for propelling a ball 20 relative to the playfield. The playfield is usually inclined from the horizontal such that the ball 20 tends to eventually roll back down the playfield in the direction of the flippers 18. The playfield accessories or devices 16 may also include elements such as bumpers or targets as well as various lights or illumination devices which may comprise lamps 22 or other devices. The playfield 14 may be covered by a transparent or glass sheet 25 to permit viewing of the playfield. In addition to the foregoing, the playfield usually includes a plunger element 32 which shoots the ball 20 up an alley 34 onto the playfield 14. Other player-activated elements, usually in the form of push-buttons (not shown) on the sides of the cabinet 12 are usually provided for controlling operation of the flippers 18.

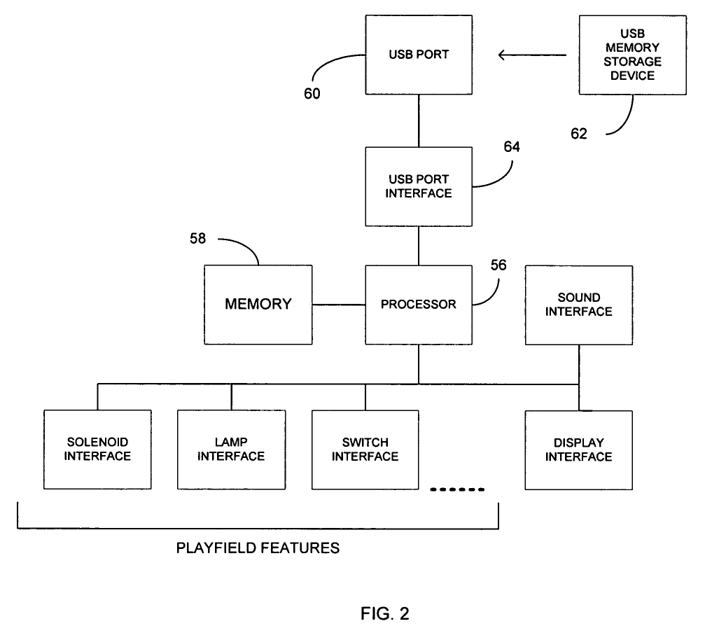

In accordance with conventional practice, the pinball machine 10 also includes a backbox 26 which is mounted to overlay a top rear portion of the cabinet 12 and which contains a game display 28, such as a dot matrix display, CRT, or the like. The backbox 26 may also support speakers (not illustrated) associated with the game sound system. Within the backbox 26 may be located various of the electronic circuits for controlling the operation of the playfield, the display, and the sound system. In the embodiment illustrated by way of example in FIG. 2, a processor 56 utilizes instructions and data stored in one or more memory devices 58 to control the operation of the various, electronic game components in a conventional manner.

To provide for the updating of programming with the memory devices 58, e.g., game control programming, sound files, video or image files, etc., the pinball machine 10 further includes a USB port 60 adapted to receive a USB memory storage device 62 on which the update information may be stored. The information may be stored on the USB memory storage device 62 by, for example, being downloaded from the Internet to computer to which the USB memory storage device 62 is later coupled. The USB memory storage device 62 may then be ported to the pinball machine 10 where it may be inserted into the USB port 60 for reading, through the cooperation of the processor 56 and USB interface 64, and storage into the system memory 58.

As concerns updating the operating software of the pinball machine, it may be preferred that the system be programmed to be able to detect multiple updates on a single memory storage device 62 and allow the operator to choose which update to install on the system. To this end, the system may also be programmed to suggest to the operator which update to install. For example, the system may determine which update is the latest one by checking the version numbers of all the updates and selecting the update with the greatest version number as the one to suggest to the operator for installation. It will be appreciated that this feature is particularly desirable since it can be expected that an operator will have many updates on a single memory storage device 62. This is particularly true since, as USB memory sticks come down in price it can be assumed that operators will not delete their old updates from the memory stick before installing new ones, e.g., each update may be approximately 32 MB, so on a 512 MB stick, the operator can store many updates. The pinball game software should, therefore, be able to detect several different versions of updates on the memory stick and prompt the operator as to which update should be installed.

It may also be desired to provide programming that will allow an operator to store a backup of the current version contained in the flash memory of the pinball game onto the flash memory of the USB memory stick. This is so that if the operator ever wanted to go back to this original version, then they would not have to download the software in the case they do not have access to a computer. In addition, operators could obtain updates from other games that have already gone through the update process, as opposed to downloading the update from the internet.

It may further be desired to provide for incremental updates. In this regard, often times when changes are made to game software, the changes do not include changes to the art and/or sound assets. Currently the binary image that is contained in the pinball game flash is divided into 3 parts: a) game image; b) art image; and c) sound image. It should be possible to update any part individually. The main reason for this is that the updates take time. To re-flash 32 MB of pinball game flash is going to take a bit of time. However, if the only change since the last version is a few lines of game code, and there are no changes to either the art or sound assets, then it will take a lot less time to simply update the 512 KB or so of game code than it would take to update the entire 32 MB of game code, art, and sound.

While a specific embodiment of the invention has been described in detail, it will be appreciated by those skilled in the art that various modifications and alternatives to those details could be developed in light of the overall teachings of the disclosure. For example, it is to be appreciated that other files may be transferred to the memory device 62 from the pinball machine, such as GAME AUDITS, GAME ADJUSTMENTS, TOURNAMENT settings, etc. Accordingly, the particular arrangement disclosed is meant to be illustrative only and not limiting as to the scope of the invention which is to be given the full breadth of the appended claims and any equivalents thereof.

All patents, patent applications, and other references cited within this document are hereby incorporated by reference in their entirety.

What is claimed is:

1. A method for updating a pinball machine, comprising:
reading from a USB memory device information pertaining to a game playable on the pinball machine;
causing the information pertaining to the game to be stored within a memory device of the pinball machine.

2. The method as recited in claim 1, wherein the information comprises instructions for playing the game.

3. The method as recited in claim 1, wherein the information comprises image data.

4. The method as recited in claim 1, wherein the information comprises sound data.

5. The method as recited in claim 1, comprising storing data read from the pinball machine on the USB memory device.

6. The method as recited in claim 5, wherein the data read from the pinball machine comprises game audit data.

7. The method as recited in claim 5, wherein the data read from the pinball machine comprises game adjustment data.

8. The method as recited in claim 5, wherein the data read from the pinball machine comprises game tournament settings data.
